(19) United States
(12) Patent Application Publication
(10) Pub. No.: US 2015/0147115 A1
(43) Pub. Date: May 28, 2015

(54) HIDDEN FASTENING DEVICE FOR BOARDS

(71) Applicant: YA YUN YANG, Taichung City (TW)

(72) Inventor: YA YUN YANG, Taichung City (TW)

(21) Appl. No.: 14/092,981

(22) Filed: Nov. 28, 2013

(51) Int. Cl. F16B 5/00; F16B 21/04

(52) U.S. Cl. CPC F16B 5/0084; F16B 21/04
USPC 403/349

(57) ABSTRACT

A hidden fastening device for boards comprises a female fastening part attached to a board, and a rotatable male fastening part attached to another board to engage with the female fastening part. The rotatable male fastening part further comprises a rotatable male fastening base with a base opening, a lock end opening, and a receiving groove, and a rotatable male lock disposed in the base opening with a male lock end at a front side thereof. The female fastening part further has a mount hole to engage with the male lock end to enable the female fastening part and the rotatable male fastening part securing to each other. The lock end opening communicates with the base opening, and the male lock end extends via the lock end opening to engage with the female fastening part. A trigger extending outward the male fastening base is received in the receiving groove when the rotatable male lock is in a state of retreating with the lock end being received in the lock end opening.

### BACKGROUND OF THE INVENTION

1. Field of the Invention

The present invention relates to a fastening device for assembling furniture, and more particularly to a hidden fastening device for boards.

2. Description of Related Art

The traditional furniture such as a desk basically includes a top board, a bottom board, two lateral boards, rear beams, drawers, and legs; these parts usually are joined to each other with screws, nails, or glues except the drawers which are movably placed in the desk.

Some of the furniture products are assembled in the factory or in the furniture store manually before the furniture can be moved to the customer. When the assembled furniture such as a desk or a cabinet is moved from the factory or the furniture store to the customer, it is costly, inconvenient, and laborious for the delivery, especially moving to higher floors in a tall building. If the furniture is damaged during moving, it is hard to be restored completely. When the furniture is serious damage, it has to be worthlessly discarded.

In order to overcome the preceding deficiencies, there are fastening devices developed for easily assembling the furniture. For instance, a rotatable fastening device, a slide fastening device and end fastening device are applied to assemble two boards perpendicular to each other. These fastening devices have a male fastening part disposed on the surface of the boards respectively, but the male fastening part bulges outward the surface of the respective board easily to scratch surfaces of other boards during moving.

Further, for the rotatable fastening device, the male fastening part thereof extends outward can be used in a space without limitation only; for the end fastening device, although it can be used in a limited space, the upper or lower end of the respective assembled board can be attached to it only to affect the firmness of the assembled boards; if the end fastening device is attached to the upper end of the assembled board, it exposes outside the board to degrade the good looking appearance of the furniture. In addition, the slide fastening device and the end fastening device are slidably attached to the assembled board respectively, and no third direction force available to restrict the reversed sliding movement effectively such that there is a potential hazard to become loosening.

Regardless design being different from each other, there is a common problem to the above-mentioned fastening devices that assembling order for the parts of the furniture is often mixed up due to the customer's misunderstanding or carelessness so as to result in that assembling the furniture is unable to be proceeded successfully during the assembling job being carried out. Under the circumferences, it is required to spend much time to detach a portion or all of the assembled parts and it is unavoidable to scratch the boards while disassembling.

### SUMMARY OF THE INVENTION

The main objective of the present invention is to provide a hidden fastening device for boards with which the boards of the furniture are arranged at correct positions with a male fastening lock being pushed to join to a female fastening part such that the boards are capable of being assembled simply, firmly, and conveniently, and no worry about the assembling order at all.

In order to achieve the object, the hidden fastening device for boards comprises a female fastening part attached to one of the boards, a rotatable male fastening part which is attached to another one of the boards to be assembled and engages with the female fastening part so as to join the two boards tightly; the rotatable male fastening part further comprises a rotatable male fastening base with a base opening, and a rotatable male lock disposed in the base opening with a male lock end at a front side thereof; the female fastening part further has a mount hole corresponding to the male lock end; the male lock end is engaged to the mount hole to allow the female fastening part and the rotatable male fastening part to secure with each other.

The rotatable male fastening base further has a lock end opening at a lateral side thereof to communicate with the base opening, and the male lock end extends via the lock end opening to engage with female fastening part; the rotatable male fastening base further has a receiving groove communicating with the base opening, and the rotatable male lock further has a trigger extending outward the male fastening base; when the rotatable male lock is in a state of retreating, the trigger is received in the receiving groove, and the male lock end is received in the lock end opening.

The female fastening part has tightening threads at the outer surface thereof.

The outer surface of the female fastening part at least has a locating tab extending outward.

It is appreciated that the hidden fastening device for boards according to the present invention provides advantages such as the lock end opening receiving the male lock end so as not to limit the space for locating the furniture, acting forces along three different directions being generated after the male lock end engaging with the female fastening part without loosening, structural strength capable increasing substantially to reach multiple effects when the hidden fastening device is used in association with other parts, the hidden fastening device capable of being used independently when the assembled furniture is subjected to small forces or the size thereof is small, and the hidden fastening device capable of being used with the slide fastening device, the end fastening device or other parts when the assembled furniture is subjected to large forces.

### BRIEF DESCRIPTION OF THE DRAWINGS

Further benefits and advantages of the present invention will become apparent after a careful reading of the detailed description with appropriate reference to the accompanying drawings:

FIG. 1 is an exploded perspective view illustrating a rotatable male fastening part of a hidden fastening device for boards according to the present invention;

FIG. 2 is a perspective view illustrating a rotatable male fastening base of the hidden fastening device for boards according to the present invention;

FIG. 3 is a perspective view illustrating a female fastening part of the hidden fastening device for boards according to the present invention;

FIG. 4 is a perspective view illustrating the hidden fastening device for boards according to the present invention in use;

### DETAILED DESCRIPTION OF THE INVENTION

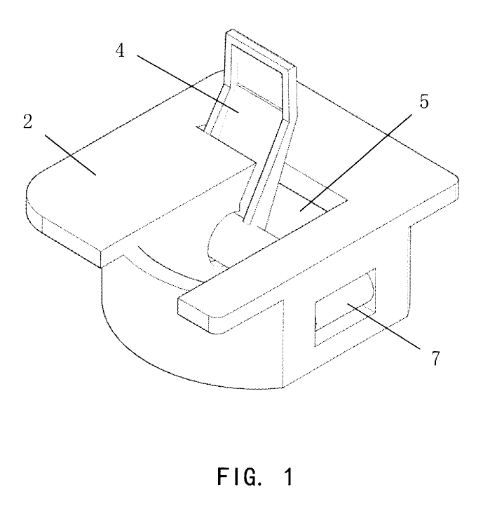

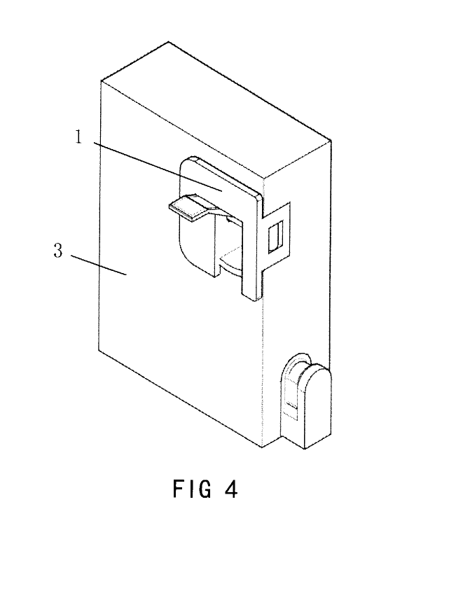

Referring to FIGS. 1, 2, 3 and 4, a preferred embodiment of a hidden fastening device for boards in accordance with the present invention comprises a female fastening part shown in FIG. 3 and a rotatable male fastening part 1 shown in FIG. 1; the female fastening part and the rotatable male fastening part 1 are secured to two assembled boards 3 as shown in FIG. 4. The rotatable male fastening part 1 shown in FIG. 1 includes a rotatable male fastening base 2 and a rotatable male lock 4; the male fastening base 2 has a base opening 5, and the rotatable male lock 4 is disposed inside the base opening 5; the rotatable male lock 4 further has a front male lock end 7. The female fastening part has a mount hole 9 disposed corresponding to the front male lock end 7, and the front male lock end 7 is engaged to the mount hole 9 to allow the female fastening part to secure with the rotatable male fastening part 1.

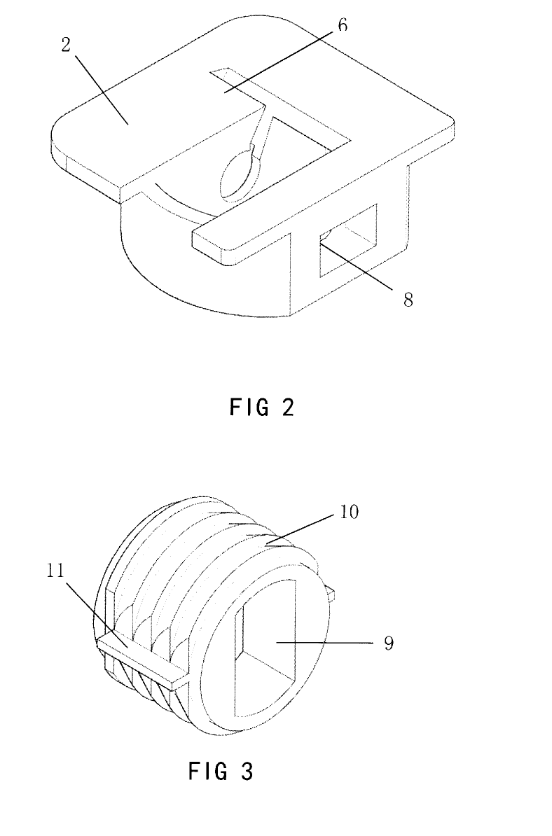

The rotatable male fastening base 2 shown in FIG. 2 has a lock end opening 8 communicating with the base opening 5, and the front male lock end 7 extends outward via the lock end opening 8 to engage with the female fastening part. The rotatable male fastening base 2 further has a receiving groove 6 communicating with the base opening 5. The rotatable male lock 4 further has a trigger; when the rotatable male lock 4 is in a state of retreating, the trigger is received in the receiving groove 6 in addition to the front male lock end 7 received in the lock end opening 8.

Further, it can be seen in FIG. 3 that the outer surface of the female fastening part is provided with tightening threads 10 and at least a flat extending outward locating tab 11.

Although the invention has been explained in relation to its preferred embodiment, it is to be understood that many other possible modifications and variations can be made without departing from the spirit and scope of the invention as hereinafter claimed.

What is claimed is:

1. A hidden fastening device for boards comprising:
a female fastening part attached to a first board;
a rotatable male fastening part, which is attached to a second board to be assembled to the first board, engaging with the female fastening part so as to join the two boards tightly;
wherein the rotatable male fastening part further comprises a rotatable male fastening base with a base opening, and a rotatable male lock disposed in the base opening with a male lock end at a front side thereof; the female fastening part further has a mount hole corresponding to the male lock end; the male lock end is engaged to the mount hole to allow the female fastening part and the rotatable male fastening part securing to each other.

2. The hidden fastening device for boards as defined in claim 1, wherein the rotatable male fastening base further has a lock end opening at a lateral side thereof to communicate with the base opening, and the male lock end extends via the lock end opening to engage with female fastening part.

3. The hidden fastening device for boards as defined in claim 1, wherein the rotatable male fastening base further has a receiving groove communicating with the base opening, and the rotatable male lock further has a trigger extending outward the male fastening base; when the rotatable male lock is in a state of retreating, the trigger is received in the receiving groove, and the lock end is received in the lock end opening.

4. The hidden fastening device for boards as defined in claim 1, wherein the female fastening part has tightening threads at the outer surface thereof.

5. The hidden fastening device for boards as defined in claim 4, wherein the outer surface of the female fastening part at least has a locating tab extending outward.
